(19) United States
(12) Patent Application Publication
(10) Pub. No.: US 2015/0095834 A1
(43) Pub. Date: Apr. 2, 2015

(54) QUOTATION INTERFACE FOR E-BOOKS

(71) Applicant: Kono Inc., Toronto (CA)

(72) Inventor: Ryan Sood, Toronto (CA)

(73) Assignee: Kobo Inc., Toronto (CA)

(21) Appl. No.: 14/041,692

(22) Filed: Sep. 30, 2013

(51) Int. Cl. G06F 3/0483; G06F 3/0484

(52) U.S. Cl. CPC G06F 3/0483; G06F 3/04842
USPC 715/776

(57) ABSTRACT

A computing device for rendering e-books, from which quotations can be selected and used to create content items. The content item can further be provided with configurations that enable the user to personalize the appearance of a selected quotation.

### TECHNICAL FIELD

Examples provided herein relate to a quotation interface for an e-book.

### BACKGROUND

“E-books” are a form of an electronic publication that can be viewed on computing devices with suitable functionality. Mufti-function devices, such as cellular-telephony or messaging devices, can utilize specialized applications (E.g., e-reader apps) to view e-books. Still further, some devices (sometimes labeled as “e-readers”) can be centric towards content viewing, and e-book viewing in particular.

### BRIEF DESCRIPTION OF THE DRAWINGS

FIG. 1 illustrates an example system for utilizing e-book, in accordance with one or more embodiments.

FIG. 2 illustrates an example of a mobile computing device in accordance with examples described herein.

FIG. 3 illustrates an example device system for providing a quotation interface, according to one or more embodiments.

FIG. 4 illustrates an example method for enabling a user to interact with an e-book in order to select and use quotations.

FIG. 5 illustrates an example of a quotation interface in accordance with one or more embodiments.

### DETAILED DESCRIPTION

Examples described herein include a computing device for rendering e-books, from which quotations can be selected and used to create content items. The content item can further be provided with configurations that enable the user to personalize the appearance of a selected quotation.

In an embodiment, a computer system includes a memory and one or more processors. The memory stores a set of instructions and an e-book. The one or more processors use the instructions in memory to render at least some pages from the e-book. The one or more processors further enable the user to specify input for selecting text from the e-book. The one or more processors further create a content item that is based on the selected text. The content item can be shared with other devices or users.

“E-books” are a form of an electronic publication that can be viewed on computing devices with suitable functionality. In this regard, e-books can provide an electronic form of literary works (e.g., novels), as well as magazines, comic books and children's books. Mufti-function devices, such as cellular-telephony or messaging devices, can utilize specialized applications (E.g., e-reader apps) to view e-books. Still further, some devices (sometimes labeled as “e-readers”) can be centric towards content viewing, and e-book viewing in particular.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

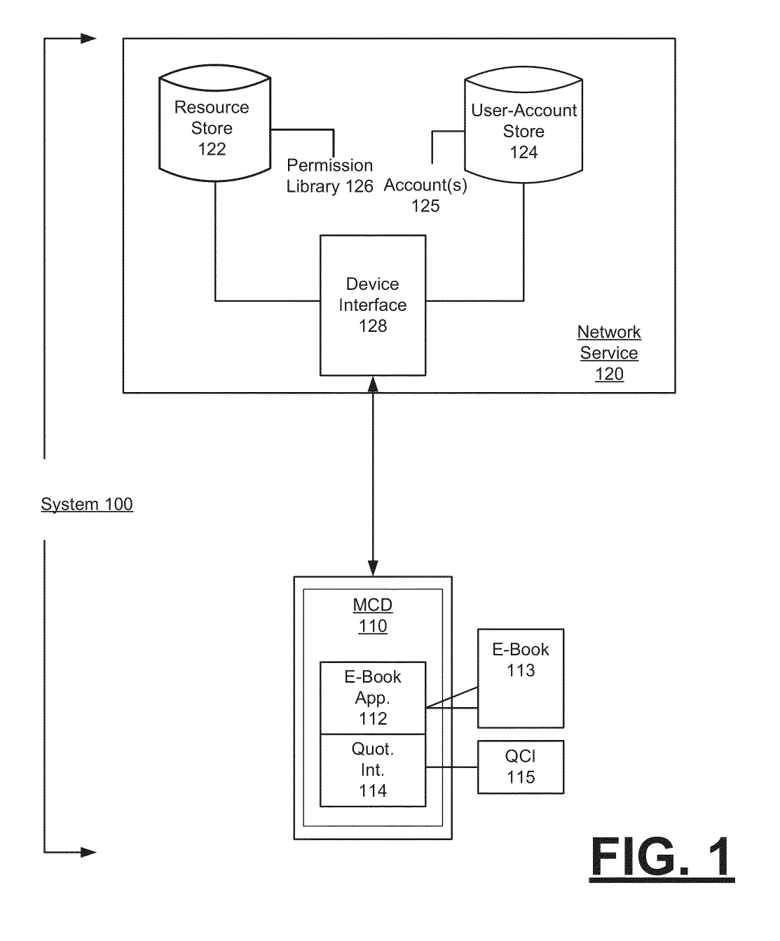

FIG. 1 illustrates a system for utilizing e-books, according to an embodiment. As described in greater detail, a system 100 can be used to implement various services and functionality related to the consumption of e-books and other digital content items, including enabling users to read e-books and extract and share quotations in a personalized form. In an example of FIG. 1, system 100 includes a mobile computing device 110 and a network service 120. The network service 120 may include multiple servers and other computing resources that provide various e-book services, including services in which e-books are sold, re-sold, shared, downloaded and/or stored. As described in greater detail below, the network service 120 can also provide a social networking environment, where users can publish, for example, reviews and/or quotations.

The mobile computing device 110 can correspond to any computing device on which an e-book can be rendered and consumed. For example, the mobile computing device 110 can correspond to a tablet, telephony/messaging device (e.g., smart phone) or portable computing device. The mobile computing device 110 can run an e-reader application that links the device to the network service 120 and enables e-books provided through the service to be viewed and consumed.

In some implementations, the mobile computing device 110 is equipped with hardware and software to optimize reading electronic content, including e-books. For example, the mobile computing device 110 can have a tablet like form factor, although variations are possible. In some cases, the mobile computing device 110 can also have an E-ink display.

The network service 120 can include a device interface 128, which communicates with individual devices that access the service. Among other resources, the network service 120 can include an e-book store 122 and a user account store 124. The e-book store 122 can provide e-books for purchase and download to the user. A permission library 126 can also be associated with the e-book store 122. The permission library 126 can dictate certain actions that a user can (or cannot) perform with respect to an e-book, such as the ability to re-transfer the e-book, share content from the e-book and/or select (and share) quotations (or quotation content items) from a particular e-book. The user account store 124 can associate mobile computing device 110 with a user and an account 125. The account 125 can also be associated with one or more e-books, which can be stored in the e-book store 122. The mobile computing device 110 may be associated with the user account 125, and multiple devices may be associated with a particular account. As described in greater detail below, the mobile computing device 110 can store e-books that are purchased or otherwise made available to the user. The mobile computing device 110 can also locally store other metadata and account information, such as meta-data that identifies which e-books the user has the right to annotate or extract quotations from.

In some embodiments, the network service 120 communicates with an application or other functionality provided on the mobile computing device 110 in order to enable a user to purchase e-books and other digital content items through the network service 120. Specific examples of purchasing activity that can be enabled for mobile computing device 110 include the ability to purchase or otherwise download e-books. Still further, other types of activities that can be enabled for mobile computing device 110 include an ability to share an experience with the digital content item with other like-minded users. For example, the network service 120 can include connectors to other social networking environments. For example, the social environment can be hosted by the network service 120 or made available through a third party.

The mobile computing device 110 can operate multiple applications, including an e-book application 112. The e-book application 112 can be used to render e-books 113 that are, for example, locally stored on the device. Each e-book 113 can, for example, correspond to a literary work, having pagination and chapter designations. In some implementations, the e-book application 112 can be paired with the network service 120 and the account 125 of the particular user. For example, the e-book application 112 can be used to enable the user to browse or search for titles, as well as to purchase or download e-books from the network service 120. The activity performed by the user through e-book application 112 can automatically be linked or otherwise associated with the account 125 of the user.

In some embodiments, a quotation interface 114 can also be executed on the computing device 110 to enable the user to select quotations from rendered e-books, as well as to personalize and publish quotations. In one implementation, the quotation interface 114 can be incorporated as functionality provided with the e-book application 112. In variations, the quotation interface 114 can be provided as a separate application or plug-in (e.g., for the e-book application 112).

When operated, the quotation interface 114 enables the user to select a quotation from any portion of the e-book 113, and further to create a quotation content item 115 that includes the selected quote. Additionally, the user can interact with the quotation interface 114 to configure or otherwise personalize the appearance of the quotation. For example, configuration such as the font, weights (e.g., line weights), size, layout, spacing, color, background selection, or relevant appearance of the quotation to the background, can be readily customized by input entered through the quotation interface 114.

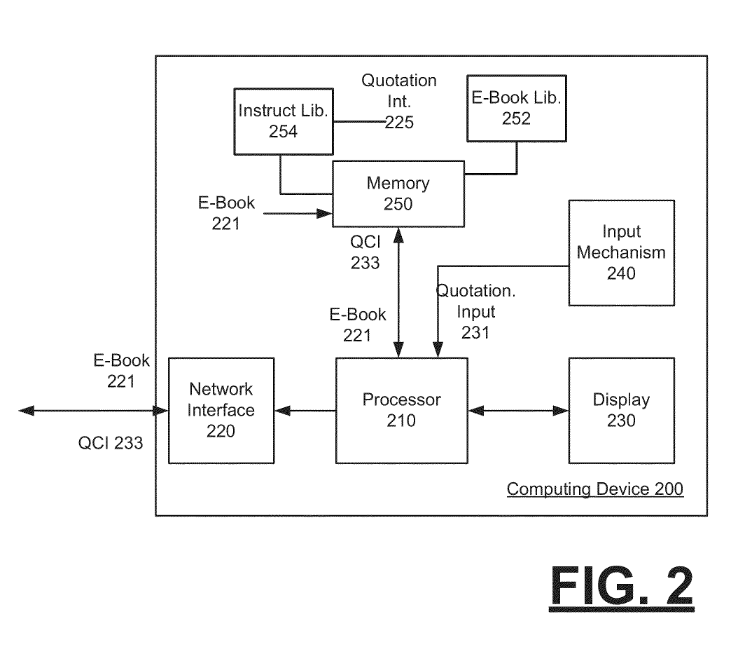

FIG. 2 illustrates an example of a mobile computing device in accordance with examples described herein. A mobile computing device 200 can be implemented as part of a system, such as described with an example of FIG. 1 (see e.g., mobile computing device 110). The mobile computing device 200 can be operated to enable the user to render e-books, and further to interact with e-books in order to select text as quotations from portions of the e-book that are selected by the user. In an example of FIG. 2, the mobile computing device 110 can include a processor 210, a network interface 220, a display 230, one or more input mechanisms 240, and a memory 250. The processor 210 can utilize the network interface 220 to communicate with a network service 120 (see FIG. 1). In communicating with the network service 120, the mobile computing device 110 can receive e-books 221 that the user has purchased or otherwise selected to download from the network service 120. The e-books 221 that are downloaded onto the mobile computing device 110 may be stored in the memory 250.

The memory 250 can store an e-book library 252 of the user. The e-book library 252 can include local copies of e-books 221 that the user has purchased or downloaded. Additionally, the memory 250 can include an instruction library 254 for enabling the execution of instructions from which various applications and other functionality can be implemented.

The display 230 can correspond to, for example, a liquid crystal display (LCD) that illuminates in order to provide content generated from processor 210. In alternative variations, for example, the display 230 can correspond to an electronic paper type display, which can be designed to mimic conventional paper in the manner in which they display content. Examples of such display technologies include electrophoretic displays, electrowetting displays, and electrofluidic displays. Examples described herein further appreciate that the media in which electronic type displays are provided can vary, and include, for example, plastic or paper combined with transistor elements or other circuitry.

The processor 210 operates to perform read operations from the instruction library 254 of memory 250 in order to implement applications such as the e-book application 112 (see FIG. 1) and the quotation interface 114 (see FIG. 1). For example, the processor 210 can retrieve stored e-books 221 from the memory 250 for rendering on the display 230. Additionally, the processor 210 can implement quotation interface instructions 225 for providing a quotation interface 114 (see FIG. 1). The user can interface with the quotation interface 114 in order to specify, for example, quotation input 231. The quotation input 231 can result in the create of a quotation content item 233, which includes selected text from a rendered e-book, as well as other customizations that are based on user-input and which change the appearance of the selected text. In some implementations, the quotation content item 233 can be stored as an image file, such as a JPEG or PNG file.

Additionally, in some embodiments, the quotation content item 233 can be copied or published via the network interface 220. For example, the quotation content item 233 can be copied onto a message that is communicated to another device or user. Still further, the quotation content item can be published onto a social networking environment, such as provided through the network service 120.

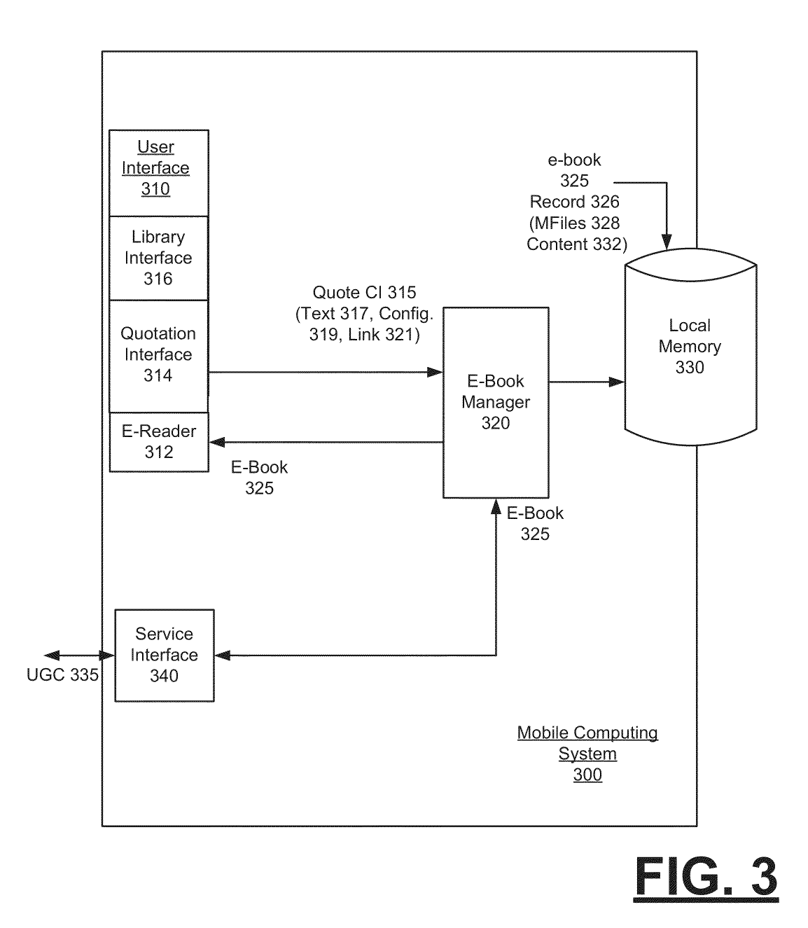

FIG. 3 illustrates an example device system for providing a quotation interface, according to one or more embodiments. In reference to FIG. 3, a mobile computing system 300 can implement programmatic components for rendering e-books, and further for providing an interface that enable a user to select and personalize quotations from rendered e-books.

In an example of FIG. 3, the mobile computing system 300 includes a user interface 310, an e-book manager module 320, a local memory 330, and a service interface 340. The programmatic components shown with the computing system 300 can be provided as part of an application that runs on, for example, a mobile computing device shown with an example of FIG. 1 or FIG. 2. For example, the user can download an application onto mobile computing device, to obtain functionality such as described herein, as well as to communicate with a network service 120. Alternatively, the application can be embedded or otherwise preinstalled with other programmatic elements for providing such functionality on a computing device.

The service interface 340 includes application and logic which enables the device to use, for example, a wireless Internet connection, to connect to the network service 120 (see FIG. 1). In connecting with the service, the service interface 340 can transmit data that enables the network service 120 to identify mobile computing system 300 (or alternatively the user) so that the network service 120 can determine the account associated with the mobile computing device. The service interface 340 can be used to retrieve e-books 325 from the network service 120. For example, in identifying the mobile computing system 300 to the network service 120, the network service may be able to procure payment information (e.g., stored credit card) that can be used to charge users account when purchasing a new e-book. Additionally, in some implementations, the service interface 340 can be used to publish user-generated content 335 originating on the computing device of mobile computing system 300. Examples of user-generated content 335 include quotation content items 315, reviews and other feedback.

The mobile computing system 300 stores acquired e-books 325 in the local memory 300. The e-books 325 can be stored as part of records 326, which specify metadata 328 and content 332. The content 332 can include pages of the e-book, as well as graphics that are provided for content. The metadata 328 can include information that identifies the e-book, including jacket art (e.g., graphics), information about the author, title, summary, user review etc. In addition, as described in greater detail below, the user can create quotation content items 315, which can be stored in the local memory 330. The quotation content items 315 can be generated to be independent of the source from which the quotation was provided. In some variations, the quotation content item 315 can be linked by metadata to the underlying content 332 or e-book 325 from which it originated. Thus, for example, an e-book can be provided with a link that locates a quotation content item 315 residing locally on the user device.

Additionally, the quotation content item 315 can be linked with the account 125 of the user on the network service 120. In this way, the quotation content item 315 can be downloaded or synced with multiple devices of the user. The quotation content item 315 can, for example, be associated with the e-book or e-reader of multiple devices of the user (which are linked to the same account).

The computing device of the mobile computing system 300 can communicate with the network service 120 in order to identify what e-books belong to the account 125 associated with the particular device or user. E-books 325 that are transmitted to the mobile computing system 300 include those that are purchased from the device, or those that the user requested to download. In variations, e-books 325 can be automatically downloaded to the device in response to the occurrence of certain conditions. For example, the user can purchase an e-book on another device, and then subsequently connect to the network service 120 via the mobile computing system 300 to automatically receive their previously purchased e-book. Alternatively, network service 120 can be configured to push e-books to the mobile computing system 300, based on, for example, user account settings, subscription rules, and various other business logic considerations.

The e-book m 320 can manage the storage of downloaded e-books in the local memory of the mobile computing system 300 for storage and use. For example, the e-book manager 320 can retrieve content and metadata from the local memory 330 in connection with a user e-book library and rendering.

In some embodiments, the user-interface 310 includes an e-reader 312, a quotation interface 314, and a library interface 316. The e-reader 312 can be used to render the content 332 from stored e-books 325 via the e-book manager 320. Additionally, the e-reader 312 can be responsive to input from the user in order to, for example, transition pages or chapters. The user can also provide input for activity with network service 120, such as sharing passages, providing feedback etc. The library interface 316 enables the user to browse and select e-books in the user's location. For example, the library interface 316 can organize the e-book collection of the user as stored in the local memory 330, and/or as recorded with the user account 125 (FIG. 1) with the network service 120. In one implementation, the library interface generates library representations of a user's e-book collection using the metadata files 328 (e.g., jacket covers) associated with the individual e-books 325 of the user collection.

In one implementation, the user can generate quotation content items 315 through the quotation interface 314. The quotation interface 314 can be provided as, for example, a plug-in or functional feature of the e-reader. In variations, the quotation interface 314 can be provided as a stand-alone application. The user can provide input through the quotation interface to select quotes from e-books, and further to edit a content item based on a selected quote. For example, the quotation interface 314 can receive input from the user corresponding to highlighting text, underlining text, or marking the text with a comment (e.g., “*”).

In an embodiment, the quotation interface 314 can enable the user to interact with any portion of the content of the e-book 325. In particular, the user can select text 317 from a given page or portion of an e-book, and copy the text 317 onto a content item 315. As an additional variation, the content item, including the text 317 can be edited using tools provided through the quotation interface 314.

In one implementation, the quotation interface 314 includes software tools and features for enabling the user to interact and edit the content item 315. In particular, the tools can enable the user to provide configurations 319 that personalize the content item 315. Among examples, the quotation interface 314 can provide tools that enable the user to format the text (e.g., change font, color or size of lettering), or alter the background (e.g., change color). Other examples include merging the text with other content, such as an image, so that the text 317 is an overlay of the image.

Additionally, the quotation interface 314 can automatically generate and embed a link 321 into the content item 315. For example, the quotation interface 314 can construct a link to the underlying e-book at the network service 120 based on an identifier of the e-book (which can be determined from the metadata files 328) and the domain of the network service 120. In one implementation, the link 321 can be selectable by any user who views the content item. Upon selection of the link, the browser or application of a given user can be navigated to a website hosted by the network service 102, and to a location at the website where the e-book 325 from which the quotation was copied is provided for purchase or download. In variations, the link 321 can locate a portion of the e-book on the user's device or account. For example, the link 321 can locate a page from the e-book, which can be provided as part of the locally stored content 332 of the e-book.

Additionally, some embodiments provide for the quotation interface 314 to identify and provide an attribution in the quotation content item 315. For example, the quotation interface 314 can access the metadata files 328 of a given e-book in order to obtain the attribution information, which can then be provided as part of the quotation content item 315. The attribution can identify the underlying e-book from which the quotation was obtained. For example, the title of the e-book can be identified and automatically included in the quotation content item 315. Optionally, the page number or chapter reference can also be identified as part of the attribution. For example, the location within the content 332 of the selected e-book 325 can be recorded by page and/or chapter and included as text or code (with the embedded link 321) in the quotation content item 315. As a variation or alternative, the author of the e-book from which the quotation was obtained can also be identified from the metadata files 328 of the selected e-book. The author can be displayed with the quote in the attribution of the quotation content item 315.

According to some examples, once the quotation content item 325 is created, it can be stored in the local memory 330 and/or published by the user. For example, the user can copy the content item onto messages, documents or other mediums. In one implementation, the content item 315 is stored as an image file (e.g., JPEG), the content item can be inserted or copied into other documents or records. Still further, in other variations, the quotation content item 315 can be communicated via the service interface 340 to the network service 120 and/or one or more social networking mediums. For example, the content item 315 can be shared on a social networking site of a user.

Still further, among other functionality, the user interface 310 can include a local online market interface to enable the user to readily access an online store for e-books. The online market interface can enable the user to purchase e-books, and to effect downloads of purchased e-books to the user device.

Methodology

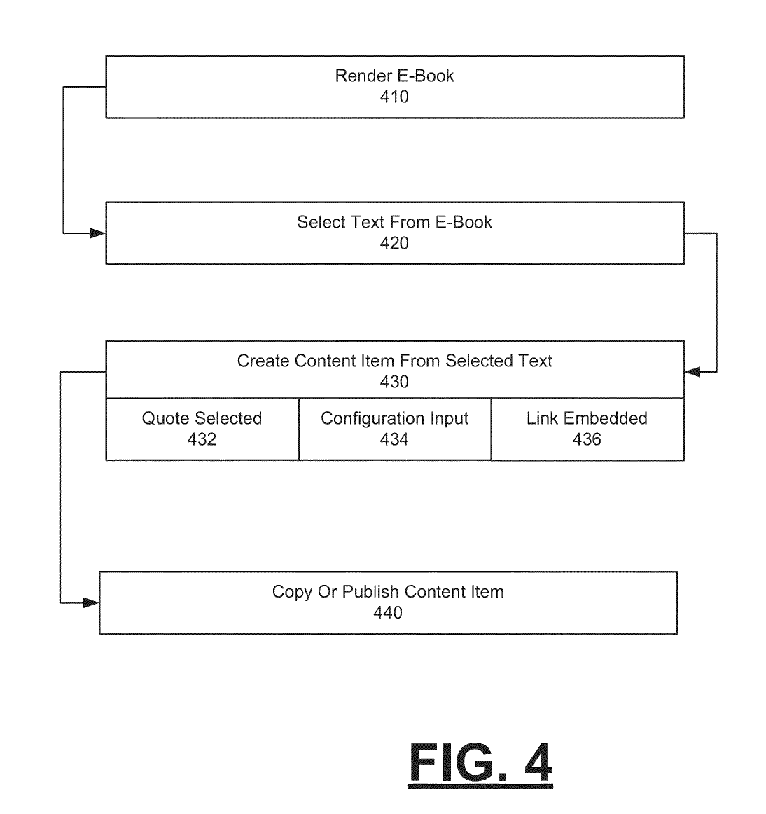

FIG. 4 illustrates an example method for enabling a user to interact with an e-book in order to select and use quotations. An example such as described by FIG. 4 or may be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, a computing device renders an e-book (410). For example, mobile computing device 200 can operate an e-book application that implements functionality of mobile computing system 300.

The user may operate the e-book application to select text from a portion of the rendered e-book (420). In some embodiments, the user can select text from any portion of the e-book of the user's choosing. For example, the user can select text from any portion of the content 332 for a given e-book 325. Thus, the user can have their choice of passage or passages from which they can select text.

In an embodiment, the e-reader 312 can be operated in a mode to select quotations (422). For example, in one implementation, the e-reader component 312 can be operated in multiple modes, including a first mode in which the content is displayed for viewing. In this mode, the user input can be interpreted as either page/chapter transition (e.g., flip page), or input to switch the mode of the e-reader. The user can provide additional input to change modes. In one implementation, the input can change the mode of the e-reader to a second mode, in which the quotation interface 314 becomes active or in focus. In this mode, the user input is interpreted for the quotation interface 314 rather than the e-reader 312. For example, the user input can be interpreted as selection input for selecting text from a portion of the rendered e-book, as well as input for operating software tools provided through the quotation interface (e.g., font adjustment, background selection or manipulation etc.).

Accordingly, in one implementation, the user's selection of text can result in the creation of a content item 315 (430). The quotation content item can include a quotation as selected by the user (432). Additionally, the quotation content item 315 can be provided with tools that enable the user to generate configurations that personalize or otherwise affect an appearance of the quotation on the content item (434). By way of example, the configurations can correspond to inputs that alter the text of the selected quotation (e.g., font, color, size) and/or alter the background of the selected text. In addition to configurations, a link can be programmatically included in the content item 315. The link can, for example, identify the underlying e-book on the network service 120 (436). Thus, selection of the link from the quotation content item results in the viewer's web browser being navigated to the network service 120 and to a page where the underlying e-book can be purchased, viewed or downloaded. The viewer can then purchase or download the e-book from which the quotation was provided.

The content item 315 can then be published or copied (440). For example, the content item 315 can be stored as a JPEG (Joint Photographic Experts Group) file, and then inserted or pasted onto a document or message where it can be communicated to another device or user. Alternatively, the content item can be uploaded to network service 120, or to another service such as a social networking page of the user.

User Interface

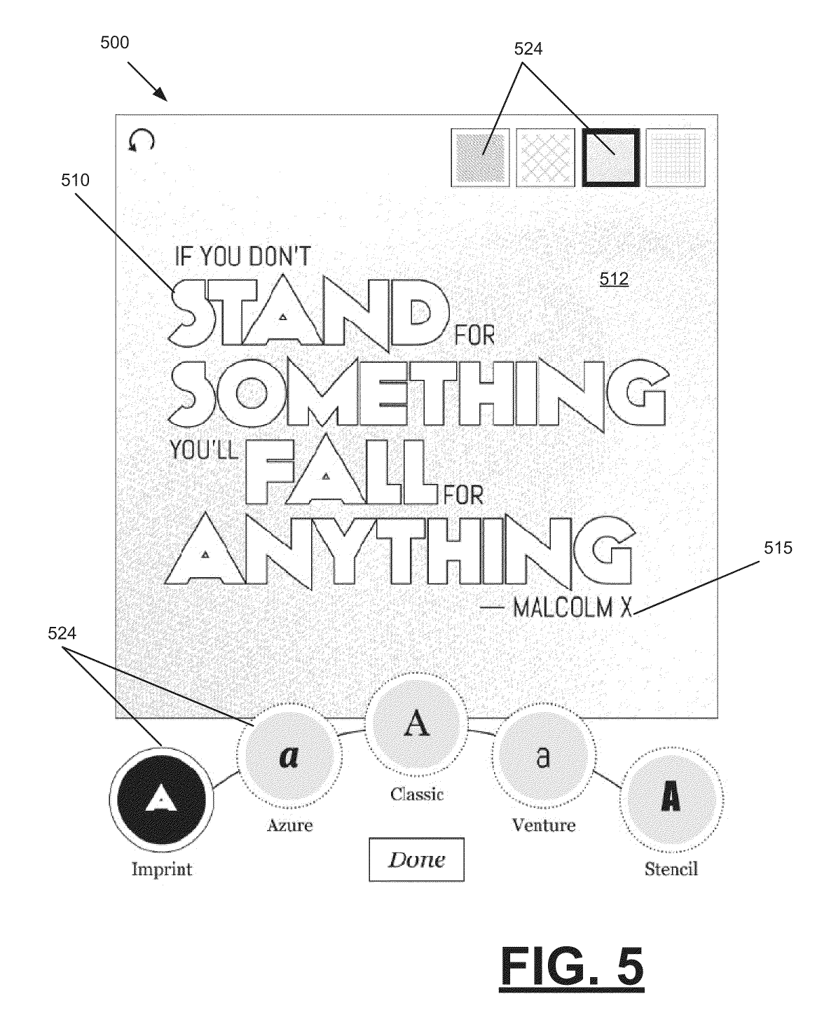

FIG. 5 illustrates an example of a quotation interface in accordance with one or more embodiments. An example content item such as shown with FIG. 5 can be provided by, for example, the user interface 310 of the mobile computing system 300 (see FIG. 3), or with the mobile computing device 110 (see FIG. 1).

In an example of FIG. 5, quotation interface 500 can render a content item in an editable mode. The content item may include a text portion 510 and a background 512. The text portion 510 can correspond to a phrase that is copied from a literary work. The text portion 510 can also be provided an attribution, which can identify a source of the phrase. The attribution 515 can identify a source of the phrase. The source can correspond to, for example, an author of a literary work (which can be embodied in an e-book) in which the phrase appears. As another example, the source can correspond to a historical figure that made the statement.

In one implementation, the quotation interface 500 renders the content item as a file that is structured as a JPEG, GIF (Graphics Interchange Format), PNG (Portable Network Graphics) or BMP (Bitmap Image File). When rendered through the quotation interface 500, the content item can be edited. The quotation interface 500 can include multiple tools to enable the user configure an appearance of the content item. In an example of FIG. 5, the tools can include (i) font selection 522, which enables the user to select the font or format of some or all of the text portion 510, and (ii) background selection 524, which enables the user to select the appearance of the background 512.

As an addition or alternative, the quotation interface 500 can enable the user to have full control of individual elements of the content item, so that the user can adjust, for example, font, weights (e.g., line weights), size, layout, spacing, color, background selection etc. using alternative tools (e.g., drawing tools). Still further, the quotation interface 500 can provide for use of tools corresponding to templates or filters.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer system comprising:
a memory that stores (i) a set of instructions, and (ii) an e-book;
one or more processors that are coupled to the memory to retrieve instructions in performing operations that include:
render at least some pages from the e-book;
select text from the e-book based on input from a user;
enable the user to create a content item that is based on the selected text; and
copy or publish the content item.

2. The computer system of claim 1, wherein the one or more processors enable the user to select text from any portion of the e-book.

3. The computer system of claim 1, wherein the one or more processors provide an interface to enable the user to create the content item.

4. The computer system of claim 1, wherein the one or more processors enable the user to reformat the selected text as part of the content item.

5. The computer system of claim 1, wherein the one or more processors enable the user to alter an appearance of a background of the content item on which the selected text appears.

6. The computer system of claim 1, wherein one or more processors operate (i) in a first mode to render at least some pages from the e-book, and (ii) in a second mode to enable the user to select the text.

7. The computer system of claim 1, wherein the one or more processors embed a link with the content item to a network location where the e-book can be downloaded.

8. The computer system of claim 1, wherein the one or more processors (i) programmatically determine an attribution of the selected text from the e-book, and (ii) display the attribution as part of the content item.

9. A method for utilizing a computing device, the method comprising:
rendering at least some pages from an e-book on the computing device;
selecting text from the e-book based on input from a user;
providing an interface on the computing device to enable the user to select text from the e-book and to create a content item that is based on the selected text.

10. The method of claim 9, further comprising transmitting the content item to another device or user.

11. The method of claim 9, further comprising publishing the content item on a network location.

12. The method of claim 9, further comprising implementing the interface to enable the user to select text from any portion of the e-book as part of the content item.

13. The method of claim 9, further comprising providing the interface to enable the user to format the selected text as part of the content item.

14. The method of claim 9, further comprising providing the interface to enable the user to alter an appearance of a background of the content item on which the selected text appears.

15. The method of claim 9, further comprising operating the computing device (i) in a first mode to render at least some pages from the e-book, and (ii) in a second mode to enable the user to select the text.

16. The method of claim 9, further comprising embedding a link with the content item to a network location where the e-book can be downloaded.

17. The method of claim 9, further comprising programmatically determining an attribution of the selected text from the e-book, and (ii) display the attribution as part of the content item.

18. A computer-readable medium that stores instructions for utilizing a computing device, the instructions being executable by one or more processors to perform operations comprising:
rendering at least some pages from an e-book on the computing device;
selecting text from the e-book based on input from a user; and
providing an interface on the computing device to enable the user to select text from the e-book and to create a content item that is based on the selected text.

19. The computer-readable medium of claim 18, further comprising instructions for implementing the interface to enable the user to select text from any portion of the e-book as part of the content item.

20. The computer-readable medium of claim 18, further comprising instructions for providing the interface to enable the user to format the selected text as part of the content item.
